(19) United States
(12) Patent Application Publication
(10) Pub. No.: US 2004/0262130 A1
(43) Pub. Date: Dec. 30, 2004

(54) Alternatively configurable roller conveyor modules assembled from interchangeable frame members

(76) Inventors: Thomas M. Brown, Vestal, NY (US); Richard T. Evans, Endicott, NY (US); Kenneth E. Gluck, Vestal, NY (US); Douglas G. Miller, Vestal, NY (US); Eugene Stradley, Owego, NY (US)

Correspondence Address: Louis J. Franco, Law Office of Louis J. Franco, 250 Arbor Street, Lunenburg, MA, 01462, US

(21) Appl. No.: 10/832,105

(22) Filed: Apr. 26, 2004

Related U.S. Application Data
(60) Provisional application No. 60/465,088, filed on Apr. 24, 2003.

(51) Int. Cl. B65G 13/07

(52) U.S. Cl. 198/781.05; 198/836.4

(57) ABSTRACT

An alternatively configurable roller conveyor module includes left and right frame members rotatably supporting rollers for rotation above roller axes extending along a roller plane. Each frame member includes upper and lower edges and includes roller-mounting apertures extending along a roller-plane axis situated between the upper and lower edges and corresponding to the intersection of the roller plane with the frame member. The roller-plane axis of each frame member is closer to the lower edge than to the upper edge of that frame member and, in various versions, each of the frame members exhibits sufficient symmetry about at least one of (a) a first plane orthogonal to the roller-plane axis of the frame member and (b) a second plane passing between the upper and lower edges of the frame member such that the left and right frame members are adapted for cooperative assembly in a roller conveyor module that is selectively configurable into at least two alternative configurations selected from among configurations including (i) a left high-wall/right high-wall configuration, (ii) a left low-wall/right low-wall, (iii) a left high-wall/right low-wall and (iv) a left low-wall/right high-wall configuration.

### PROVISIONAL PRIORITY CLAIM

Priority based on Provisional Application Ser. No. 60/465,088, filed Apr. 24, 2003, and entitled “ALTERNATIVELY CONFIGURABLE ROLLER CONVEYOR MODULES ASSEMBLED FROM INTERCHANGEABLE FRAME MEMBERS,” is claimed.

### BACKGROUND

1. Field

Although not so limited in its utility or scope, implementations of the present invention are particularly well suited for incorporation in intra-facility transport systems such as those used in moving mail pieces and mail-piece containers through various stages of processing in a mail processing facility, for example.

2. Brief Description of an Illustrative Environment and Related Art

Large-scale material handling operations frequently involve the use of intra-facility transport systems such as conveyor belts and power roller conveyors. A module of a typical power roller conveyor includes a roller support structure defined by first and second laterally spaced, elongated frame members arranged in parallel and extending along a central longitudinal axis. Extending between, and supported by, the parallel frame members is a plurality of rollers, each of which rollers rotates about an axis perpendicular to the central longitudinal axis and parallel to the axes of other rollers among the plurality. The axes of the rollers are typically spaced apart in accordance with recognized industry-standard specifications. For instance, the roller spacing (i.e., distance between the roller axes) of a typical power roller conveyor in a mail-processing facility is 3 inches. Regardless of the roller spacing peculiar to a particular industry or application, the roller spacing in any particular power roller conveyor is typically fixed. Moreover, a roller conveyor module typically includes some whole number multiple of a region or “zone” wherein each zone includes, for example, one motorized roller, an optical barrier, one or more cross members bridging and securing in fixed relationship the left and right frame members, and fastener-receiving apertures and/or brackets for supporting all manner of apparatus including, for example, the optical barrier components (e.g., an emitter and receiver), a material transfer module, and cross members. In a typical roller conveyor system, a zone can be thought of as a pattern repeat. Each zone is of a predetermined length (e.g., 30″) with modules or sections having lengths 30″, 60″, 90″ or 120″, for example.

When there exists a desire to modify a straight run of roller conveyor by incorporating a divert or merge assembly, for example, plant managers resort to the purchase of prefabricated sections of roller conveyor to replace existing straight-only sections. At least one zone is removed from the structure to be modified and replaced with the desired diverge/merge unit. Conventional examples of merge/divert units include pre-fabricated, dedicated, substantially “y-shaped” and “T-shaped” replacement sections that enable diversion/merging to the left or right with respect to an arbitrarily selected material flow direction at different industry-standard angles (e.g. 30°, 45° and 90°). These units are cumbersome, heavy, expensive and costly to ship and install.

As manufactures and purchasers of roller conveyors are aware, in addition to the expense and difficulty encountered in integrating a pre-fabricated divert/merge unit into an existing roller conveyor line, even conventional straight, non-diverging/mlrging roller conveyor modules are sold in dedicated high-wall/high-wall, low-wall/low-wall and high-wall/low-wall configurations for different purposes. For example, high-wall/high-wall sections provide material-containment guides on either side of a roller conveyor module, but preclude the movement of “oversized” packages over their rollers. Low-wall/low-wall configured roller-conveyor modules are incorporated for the transport of oversized packages. High-wall/low-wall configurations provide a material guide or backstop on one side of a conveyor module while obviating the need to lift packages or containers over a wall on the low-wall side for placement upon the rollers. High-wall/low-wall configurations are especially useful in arrangements in which materials are deposited onto the roller conveyor from the low-wall side and in a direction substantially orthogonal to the roller conveyor in order to prevent deposited material from dropping off the side opposite the low-wall side (i.e., the high wall serves as a material backstop).

Each of the aforementioned dedicated configurations serves legitimate functions.

However, alternative dedicated configurations add to fabrication, warehousing, parts-stocking and unit-purchasing costs.

Accordingly, there exists a need for roller-conveyor-module components and methods of assembling and configuring roller conveyor modules that render less expensive the cost of production and purchase of components for the reconfiguration of roller conveyor sections and the cost and time required for such reconfigurations.

### SUMMARY

### Straight (Linear) Embodiments

In various embodiments, a roller conveyor module includes a roller support structure having first and second ends and first and second laterally spaced, elongated left and right side frame members arranged in parallel and extending between the first and second ends of the roller support structure along a central longitudinal axis. Extending between, and supported by, the parallel frame members is a plurality of rollers, each of which rollers rotates about an axis perpendicular to the central longitudinal axis and parallel to the axes of other rollers among the plurality. The roller axes of the rollers supported by the support structure lie along a roller plane and, in a typical version, are spaced equally in accordance with a predetermined roller-axis spacing.

The left and right side frame members are first and second frame members fabricated in accordance with the same set of specifications such that, for example, the frame members would, in accordance with a typical stock part numbering system, be assigned the same part number. Each of the first and second frame members extends along a longitudinal frame-member axis and, as determined by the specification set in accordance with which the first and second frame members are fabricated, has an upper edge and a lower edge, a wall including pre-designated inner and outer faces and first and second longitudinally opposed ends. Each of the first and second frame members further includes a feature set including constituent features arranged such that there exists at least one of (i) a first common plane orthogonal to the longitudinal axis of the frame member with respect to which first common plane each feature of a first selected subset of features in the feature set on one side of the first common plane has a symmetrically situated counterpart on the opposite side of the first common plane and (ii) a second common plane passing between the upper and lower edges of the frame member with respect to which second common plane each feature of a second selected subset of features in the feature set on one side of the second common plane has a symmetrically situated counterpart on the opposite side of the second common plane. Typically, the second common plane at least one of (a) includes and (b) extends parallel to the longitudinal axis of the frame member. In various illustrative alternative embodiments, the features within a feature set include at least one of (i) fastener-apertures adapted for receiving, for instance, bolts, screws, clips or rivets used for retaining frame-member-retaining cross-members and/or joining the roller conveyor module to an adjacent conveyor module; (ii) apertures for the receipt of optical barrier apparatus; (iii) apertures (windows) for facilitating the passage of electromagnetic energy emitted from an emitter for detection by a receiver of cooperating optical barrier apparatus and any of (iv) brackets, bracket mounts and braces for selectively retaining one of the first and second frame members in fixed relationship with the other of the first and second frame members, by way of non-limiting example. It will be appreciated that any one of the aforementioned features may itself be divided by either of the first and second common planes. For example, an aperture centered between the first and second ends and the upper and lower edges of a frame member would be “quartered” by the intersection of first and second common planes passing through, respectively, a longitudinal midpoint and a midpoint between the upper and lower edges of the frame member. In such a case, one quarter of the aperture would be a single feature having symmetrical counterparts on the opposite sides of each of the first and second common planes.

In various implementations, the roller-mounting aperture set of each of the first and second frame members is a feature set for which each roller-mounting aperture of a selected subset of roller-mounting apertures on one side of the first common plane has a symmetrically situated counterpart on the opposite side of the first common plane. In a typical version, the roller-mounting aperture set includes roller-mounting apertures extending longitudinally on one side of the second common plane and arranged such that a single roller-plane axis passes through each of the apertures in the roller-mounting aperture set. Moreover, the roller-plane axis is displaced by a first distance from the upper edge of the frame member and by a second distance, lesser in magnitude than the first distance, from the lower edge of the frame member such that the roller-plane axis is closer to the lower edge than to the upper edge. The inclusion of features other than roller-mounting apertures in a feature set exhibiting sufficient symmetry about both the first and second common planes renders unnecessary the inclusion of a symmetrical counterpart for the roller-mounting aperture set on the opposite side of the second common plane and renders each frame usable, without post-fabrication modification, as either the left or right frame member in an assembled roller-support structure in either a high-wall or low-wall orientation. More specifically, the first and second frame members can be alternatively incorporated into an assembled roller conveyor module, with at least a portion of the inner face of one frame member facing at least a portion of the inner face of the other frame member such that there exists lateral alignment among features in the feature set of the left frame member with like features in the feature set of the right frame member, in one of (i) a high-wall/high-wall configuration; (ii) a low-wall/low-wall configuration and a (iii) high-wall/low-wall configuration. A high-wall/high-wall configuration is one in which each of the first and second frame members is secured in parallel with the other of the first and second frame members with the upper edge of each frame member disposed above the roller plane, the lower edge of each frame member disposed below the roller plane and the first end of each frame member laterally opposite the second end of the other frame member. A low-wall/low-wall configuration is one in which each of the first and second frame members is secured in parallel with the other of the first and second frame members with the upper edge of each frame member disposed below the roller plane, the lower edge of each frame member disposed above the roller plane and the first end of one frame member laterally opposite the second end of the other frame member. A high-wall/low-wall configuration is one in which each of the first and second frame members is secured in parallel with the other of the first and second frame members, the upper edge of one frame member is disposed below the roller plane, the upper edge of the other frame member is disposed above the roller plane and the first end of each frame member is laterally opposite the first end of the other frame member. It will be a appreciated, especially upon review of the detailed description, that with respect to a material flow direction with reference to which left and right frame members are designated, two high-wall/low-wall configurations are attainable: a left high-wall/right low-wall configuration and a left low-wall/right high-wall configuration. It is to be understood that “laterally aligned” features are, in various configurations, not necessarily at the same altitude above or below a specified plane (e.g., the roller plane); instead, lateral alignment is defined sufficiently broadly so as to include features in the first and second frame members through which a single plane orthogonal to the frame members passes, regardless of relative altitude.

In some versions, a roller-conveyor-module framing kit is adapted for incorporation in an assembled straight roller conveyor module and includes first and second longitudinally extending frame members that are fabricated in accordance with a common specification set and that can be assembled into alternative configurations selected from the configurations described above. The frame members of one illustrative kit include roller-mounting apertures adapted to receive and rotatably support separately obtained industry-standard rollers and are selectively supportable in fixed relationship with respect to one another by commercially available cross members. Alternative illustrative kits include at least one of (i) a set of rollers for rotatable retention between the assembled first and second frame members and (ii) cross members for retaining the first and second frame members in fixed, assembled relationship.

### Curved (Arcuate) Embodiments

In various embodiments, an alternatively configurable curved roller conveyor module includes a roller support structure having first and second ends and inner and outer radially spaced, arcuate frame members concentric about a center wherein the inner frame member is of a lesser radius (i.e., radius of curvature) than the outer frame member. Extending between, and supported by, the radially spaced frame members is a plurality of rollers, each of which rollers rotates about a roller axis radially emanating from the center and converging toward the center with respect to the axes of other rollers among the plurality. Moreover, the roller axes of the rollers supported by the support structure lie along a roller plane.

Each of the inner and outer frame members has an arcuate wall having an upper edge and a lower edge, predetermined inner and outer faces and first and second arcuately opposed ends. Although the module is alternatively configurable, in each assembled configuration, at least a portion of the inner face of the inner frame member faces the inner face of the outer frame member such that there exists lateral (radial) alignment among features in a feature set of the inner frame member with like features in a feature set of the outer frame member, the feature sets being more fully explained further in this description. “Lateral alignment” of features included in curved embodiments is defined analogously to “lateral alignment” applicable to straight embodiments; more specifically, laterally aligned features need not be at the same altitude relative, for example, to the roller plane.

In various embodiments, the inner and outer arcuate frame members include, respectively, first and second sets of roller-mounting apertures arranged to facilitate the radial emanation, from the center, of each of the rollers supported between the frame members and such that the roller plane along which the roller axes lie passes through each roller-mounting aperture in each of the first and second aperture sets. The roller plane passing through each of the arcuate frame members typically passes through locations corresponding to the geometric centers of round, square, hexagonal or other regular polygonal roller-mounting apertures. In any event, the arrangement of the roller-mounting apertures along each arcuate frame member is such that there exists an arcuate roller-plane axis passing through the roller-mounting apertures in the aperture set that corresponds to the position of intersection, in an assembled curved roller support structure, of the roller plane and the arcuate frame wall. The aperture set of the inner arcuate frame member is further arranged such that the arcuate roller-plane axis is displaced by a first distance from the upper edge of the arcuate frame member wall and by a second distance from the lower edge of the arcuate frame member wall. The second distance is lesser in magnitude than the first distance such that, in any particular assembled configuration, the roller plane axis is closer to the lower edge of the inner frame member than to the upper edge. Analogously, the aperture set of the outer arcuate frame member is arranged such that the arcuate roller-plane axis is displaced by a first distance from the upper edge of the arcuate frame member wall and by a second distance from the lower edge of the arcuate frame member wall with the second distance being lesser in magnitude than the first distance.

Relative to each of the inner and outer frame members, there exists a plane passing through a mid-point along the arc-length of the frame wall, and orthogonal to the arcuate roller-plane axis, about which the frame member is sufficiently symmetric to permit the alternative use of the frame member in each of four attitudes such that the roller support structure of which that frame member is a part can be caused to alternatively assume each of eight configurations with respect to a material-flow direction. For instance, each of the inner and outer frame members can be caused to assume a low-wall attitude or a high-wall attitude independent of the attitude of the opposite frame member. Accordingly, the roller conveyor module can be configured, alternatively, in each of (i) a low-wall/low wall configuration, (ii) a high-wall/high-wall configuration, (iii) an inner low-wall/outer high-wall configuration and (iv) an inner high-wall/outer low wall configuration. Moreover, with respect to an arbitrarily designated material flow direction (e.g., from the first end to the second end of the roller support structure), the frame members can be arranged to curve to the left or to the right, as directionally defined with reference to the material flow direction, thereby doubling the aforementioned four configurations possible for each direction to eight. Obviously, if one of the inner and outer frame members in the assembly is in an attitude consistent with a left-curving conveyor module, the other of the inner and outer frame members cannot be in a right-curving attitude. With respect to, and logically consistent with, material flow direction as viewed from above, for example, each of the inner and outer frame members can alternatively be referred to as left side and right side frame members. For instance, in a left-curving configuration, the inner (shorter) frame member can be referred to as the left side frame member and the longer outer frame member referred to as the right side frame member. Conversely, in a right-curving conveyor module configuration, the longer outer frame member assumes the position of left side frame member to the shorter inner frame member's role as right side frame member.

Although eight possible configurations have been mentioned for an implementation in which each of the inner and outer frame members includes a feature set exhibiting sufficient symmetry about both of two common planes, it is to be understood that within the scope and contemplation of the invention are embodiments wherein at least one of the inner and outer frame members includes a feature set that exhibits sufficient symmetry about at least one of (a) a first common plane orthogonal to the roller plane axis of the frame member and (b) a second common plane passing between the upper and lower edges of the frame member such that the inner and outer frame members are adapted for cooperative assembly in a roller conveyor module that is selectively configurable into at least two alternative configurations selected from among at least two configuration sets; namely a first configuration set including four alternative configurations and a second configuration set including four alternative configurations. Configurations in the first configuration set are such that the first end of the inner frame member is laterally opposite the first end of the outer frame member while configurations in the second configuration set are such that the first end of each of the inner and outer frame members is laterally opposite the second end of the other frame member (i.e., one frame member is inverted with respect to the other frame member). It will be more fully appreciated upon review of the detailed description and the accompanying drawings that for each configuration in each of the two configuration sets, the inner and outer frame members are in the same orientation relative to one another, but that the entire assembly is orientable into each of four attitudes in order to achieve the four configurations of the configuration set.

For purposes of clarity of description, each of various configurations is briefly described including the alternative attitudes each of two illustrative “universally symmetric” frame members (i.e., frame members sufficiently symmetric about each of the two previously described common planes) is caused to assume in order to achieve that configuration. Although the initial designation of first and second ends and upper and lower edges, for example, of each frame member is entirely arbitrary, once attributed, these designations are held constant with respect to each frame member so that the orientation of each frame member in various roller-support structure configurations is more comprehensible. Accordingly, the designations of frame-member ends and edges are set in this description with respect to a left-curving, high-wall/high-wall configuration as viewed from above. The configurations, and the frame-member orientations within the various configurations, will be more clearly understood through examination of the detailed description and the drawings referred to therein.

A high-wall/high wall, left-curving configuration of a curved roller conveyor module is one in which each of the inner and outer frame members is secured concentrically with the other of the inner and outer frame members with the upper edge of each frame member disposed above the roller plane, the lower edge of each frame member disposed below the roller plane and the first end of the inner frame member laterally opposite the first end of the second frame member. In a high-wall/high-wall, left-curving configuration, the first ends of each of the inner and outer frame members correspond to the first end of the roller-support structure. Moreover, the fact that in a high-wall/high-wall configuration, the inner wall and outer walls extend above the roller plane by distances greater than distances by which they extend below the roller plane, provides an upwardly extending material guide on each side of the roller conveyor module to inhibit material from falling therefrom. In a high-wall/high-wall, right-curving configuration, the upper edge and lower edge of each one of the inner and outer frame members is, respectively, disposed above and below the roller plane. Moreover, just as in the left-curving configuration, the first ends of the inner and outer frame members are laterally opposite one another. However, in the right-curving, high-wall/high-wall configuration, the first ends of the inner and outer frame members, instead of corresponding to the first end of the roller-support structure, correspond to the second end of the roller support structure. That is, material flowing through the curved roller conveyor module will “encounter” the second ends of the frame member prior to encountering the first ends of the roller conveyor module.

In a low-wall/low-wall, left-curving configuration, each of the inner and outer frame members is secured concentrically with the other of the inner and outer frame members with the upper edge of each frame member disposed below the roller plane, the lower edge of each frame member disposed above the roller plane and the first end of the inner frame member laterally opposite the first end of the second frame member. However, in a left-curving low-wall/low-wall configuration, the first ends of each of the inner and outer frame members correspond to the second end of the roller-support structure. In a low-wall/low-wall, right-curving configuration, the inner and outer frame members are secured concentrically with the lower edge of each frame member above the roller plane and the second ends of each frame member corresponding to the second end of the roller-support structure.

Each of the four configurations just described are of the first configuration set because, in each instance, the first ends of the inner and outer frame members are laterally opposed and, in any particular assembly orientation, the upper edges of the frame members are on the same side of the roller plane (i.e., either above or below). In the following four configurations of the second configuration set, the first end of one frame member is laterally opposite the second end of the other frame member and the upper edges of the inner and outer frame members are, in any particular assembly orientation, on opposite sides of the roller plane.

In a left-curving, inner high-wall/outer low-wall configuration, the inner frame member is in the left position with its upper edge above the roller plane, while the outer frame member is in the position of right side frame member with its lower edge above the roller plane. The first end of the inner frame member is laterally opposite the second end of the outer frame member and corresponds to the first end of the roller support structure. In a right-curving, inner high-wall/outer low-wall configuration, the inner frame member is in the position of right side frame member with its upper edge above the roller plane, while the outer frame member is in the position of left side frame member with its lower edge above the roller plane. Moreover, in this right-curving configuration, the first end of the outer frame member is laterally opposite the second end of the inner frame member and corresponds to the first end of the roller support structure.

In a left-curving, inner low wall/outer high-wall configuration, the lower edge of the inner (left) frame member is above the roller plane and the upper edge of the outer (right) frame member is above the roller plane. The second end of the inner frame member is laterally opposite the first end of the outer frame member and corresponds to the first end of the roller-support structure. In a right-curving, inner low-wall/outer high-wall configuration, the inner frame member is in the position of right side frame member with the lower edge thereof above the roller plane and the outer frame member is in the position of left side frame member with its upper edge above the roller plane. The first end of the inner frame member is laterally opposite the second end of the outer frame member and corresponds to the first end of the roller support structure.

In some versions, a roller-conveyor-module framing kit is adapted for incorporation in an assembled curved roller conveyor module and includes first and second arcuate frame members of differing radii of curvature that can be assembled into alternative configurations selected from the configurations described above. The frame members of one illustrative kit include roller-mounting apertures adapted to receive and rotatably support separately obtained industry-standard rollers and are selectively supportable in fixed relationship with respect to one another by commercially available cross members. Alternative illustrative kits include at least one of (i) a set of rollers for rotatable retention between the assembled first and second frame members and (ii) cross-braces for retaining the first and second frame members in fixed, assembled relationship.

Representative, non-limiting embodiments of alternatively configurable roller conveyor modules are more completely described and depicted in the following detailed description and the accompanying drawings. Moreover, it is to be understood that where certain aspects applicable expressly or by analogy to either a straight or curved embodiment have been described more completely with respect to one or the other of a straight or curved embodiment, referential reliance may be invoked to support the description and appended claims associated with embodiments for which such aspects are less completely described or, indeed, not described at all. By way of non-limiting example, if a particular feature is enumerated in describing a feature set associated with a curved embodiment, it is to be understood that that description supports, by analogy, the association of that feature with a straight embodiment.

### BRIEF DESCRIPTION OF THE DRAWINGS

FIG. 1A is a top view of an illustrative straight, alternatively configurable roller conveyor module including three zones;

FIG. 1B is a side view of the roller conveyor module of FIG. 1A;

FIG. 1C is an end view of the conveyor module of FIGS. 1A and 1B as viewed into the first end;

FIGS. 2A through 2D are end views of an alternatively configurable roller conveyor in, respectively, high-wall/high-wall, low-wall/low-wall, high-wall/low-wall and low-wall/high-wall configurations;

FIG. 3A is a top view of an alternatively configurable roller conveyor module configured joined by spur-bracket assembly components to a merging/diverging roller conveyor module;

FIG. 3B depicts components of an illustrative spur-bracket assembly;

FIG. 3C is a top view of a spur-bracket assembly fastened to an alternatively configurable roller conveyor module in the absence of a merging/diverging roller conveyor module;

FIG. 4A is a top view of an illustrative curved, alternatively configurable roller conveyor module in a left-curving, high-wall/high-wall configuration;

FIG. 4B is a side and first-end view of the roller conveyor module of FIG. 4A;

FIGS. 5A through 5D are top views of a curved, alternatively configurable roller conveyor module configured in four alternative left-curving configurations including high-wall/high-wall, low-wall/low-wall, inner high-wall/outer low-wall and inner low-wall/outer high-wall configurations; and

FIGS. 5E through 5H are top views of a curved, alternatively configurable roller conveyor module configured in four alternative right-curving configurations including high-wall/high-wall, low-wall/low-wall, inner high-wall/outer low-wall and inner low-wall/outer high-wall configurations.

### DETAILED DESCRIPTION

The following description of various embodiments of alternatively configurable roller conveyor modules is illustrative in nature and is therefore not intended to limit the scope of the invention or its application of uses.

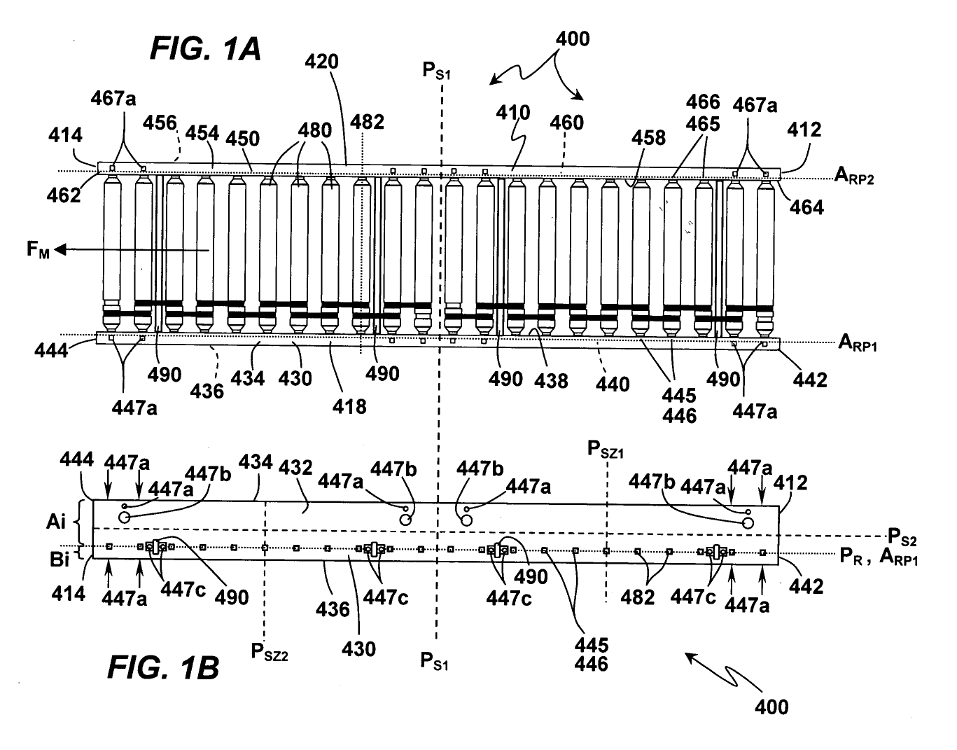

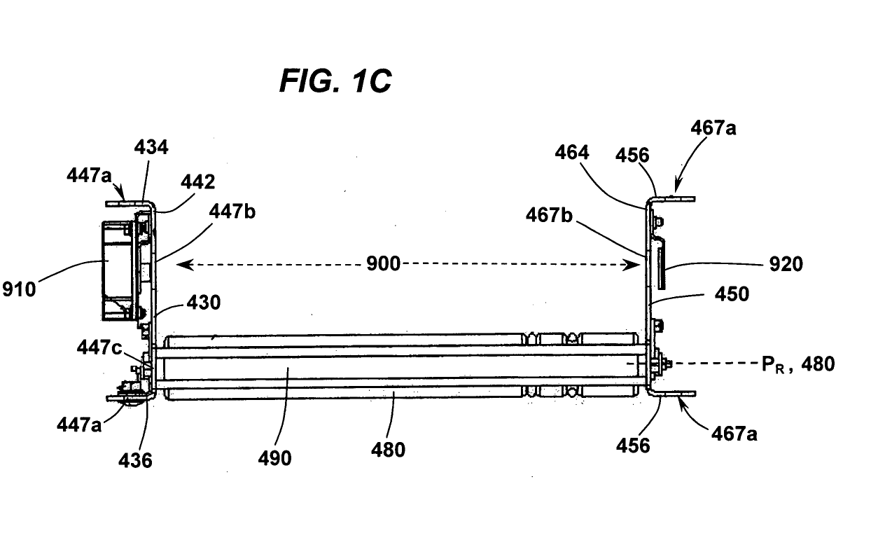

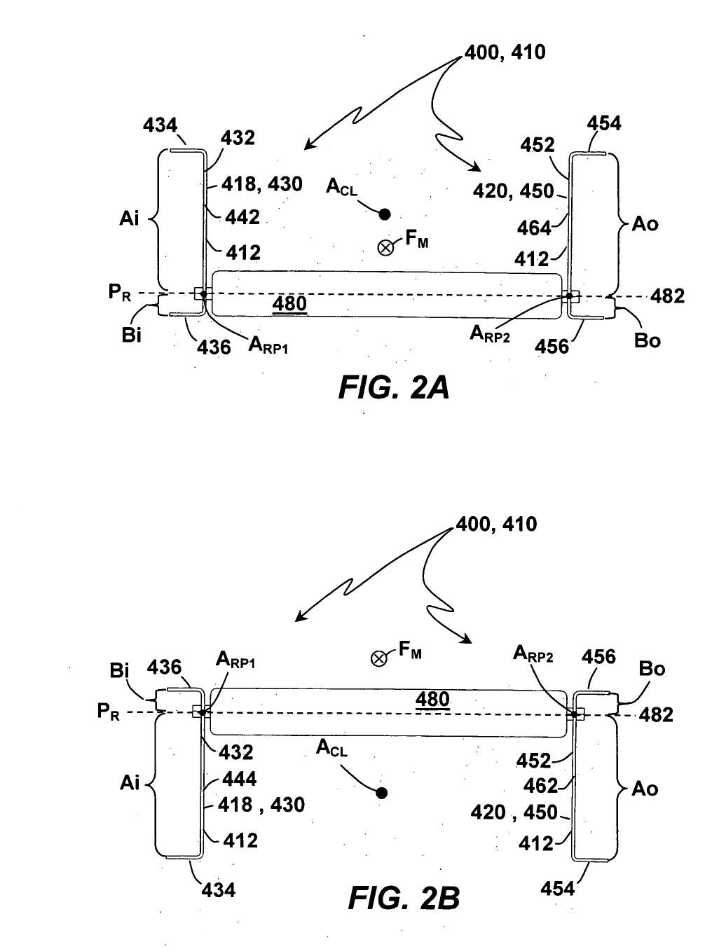

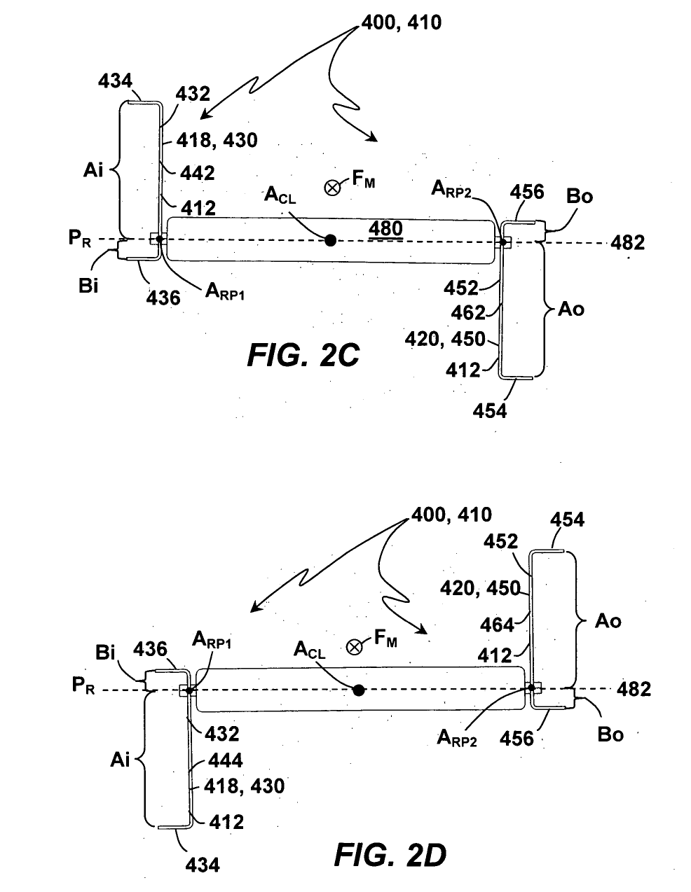

Referring to FIG. 1A through 2D, an illustrative embodiment of a straight, alternatively configurable roller conveyor module 400 includes a roller support structure 410 having first and second ends 412 and 414 and first and second laterally spaced, elongated frame members 430 and 450 arranged in parallel and extending between the first and second ends 412 and 414 of the roller support structure 410 along a central longitudinal axis A_{CL}. As will be more fully appreciated later in this description, and through review of the drawings, in alternative configurations, each of the first and second frame members 430 and 450 can alternatively assume the position of left and right frame members 418 and 420 of the roller support structure 410, depending on the desired configuration.

Extending between, and supported by, the parallel first and second frame members 430 and 450 is a plurality of rollers 480, each of which rollers 480 rotates about a roller axis 482 perpendicular to the central longitudinal axis AcL and parallel to the axes 482 of other rollers 480 among the plurality. The roller axes 482 of the rollers 480 supported by the support structure 410 lie along a roller plane PR and, in a typical version, are spaced equally in accordance with a predetermined roller-axis spacing.

In a typical embodiment, the left and right side frame members 418 and 420 are first and second frame members 430 and 450 fabricated in accordance with the same set of specifications such that, for example, the frame members would, in accordance with a typical stock part numbering system, be assigned the same part number.

The first frame member 430 has a wall 432 including upper and lower edges 434 and 436, predetermined inner and outer faces 438 and 440 and first and second longitudinally opposed ends 442 and 444. Similarly, the second frame member 450 has a wall 452 including an upper edge 454 and a lower edge 456, predetermined inner and outer faces 458 and 460 and first and second longitudinally opposed ends 462 and 464. In various versions, the upper and lower edges 434 and 436 of the first frame member 430 and the upper and lower edges 454 and 456 of the second frame member 450 include outwardly extending flanges as shown in the illustrated versions. Although the roller conveyor module 400 is alternatively configurable by the alternative orientation of the first and second frame members 430 and 450 with respect to one another, in each assembled configuration, at least a portion of the inner face 438 of the first frame member 430 member faces the inner face 458 of the second frame member 450.

In various embodiments, the first and second frame members 430 and 450 include, respectively, first and second roller-mounting aperture sets 445 and 465 including roller-mounting apertures 446 and 466 arranged to facilitate the lateral extension of each of the rollers 480 supported between the first and second frame members 430 and 450 such that the roller plane P_{R} along which the roller axes 482 lie passes through each of the roller-mounting apertures 446 and 466 in, respectively, each of the first and second aperture sets 445 and 465. The roller plane P_{R} passing through each of the frame members 430 and 450 typically passes through locations corresponding to the geometric centers of round, square, hexagonal or other regular polygonal roller-mounting apertures 446 and 466. In any event, the arrangement of the roller-mounting apertures 446 and 466 along each of, respectively, first and second frame members 430 and 450 is such that there exists a roller-plane axis passing through the roller-mounting apertures in the roller aperture set of each frame member 430 and 450 that corresponds to the position of intersection, in an assembled roller support structure 410, of the roller plane P_{R} and the frame wall. These roller-plane axes are identified in the drawings as A_{RP1} and A_{RP2} passing through, respectively, the first roller aperture set 445 of the first frame member 430 and the second roller aperture set 465 of the second frame member 450.

As shown in FIGS. 1A through 2D, the first aperture set 445 of the first frame member 430 is further arranged such that the first roller-plane axis A_{RP1} is displaced by a first distance Aᵢ from the upper edge 434 of the first frame member wall 432 and by a second distance Bᵢ from the lower edge 436 of the wall 432. The second distance Bᵢ is lesser in magnitude than the first distance Aᵢ such that, in any particular assembled configuration, the first roller plane axis A_{RP1} is closer to the lower edge 436 of the first frame member 430 than to the upper edge 434. Analogously, the second aperture set 465 of the second frame member 450 is arranged such that the second roller-plane axis A_{RP2} is displaced by a first distance A_{O} from the upper edge 454 of the second frame member wall 452 and by a second distance B_{O} from the lower edge 456 of the wall 452 with the second distance B_{O} being lesser in magnitude than the first distance A_{O}. In embodiments in which the first and second frame members are fabricated in accordance with the same specifications set, Aᵢ and A_{O} are of equal magnitude and Bᵢ and B_{O} are of equal magnitude.

As shown in FIGS. 1A and 1B, relative to each of the first and second frame members 430 and 450, there exists a first common plane P_{S1} passing through a mid-point along the length of the frame wall, and orthogonal to the roller-plane axis (i.e., each of A_{RP1} and A_{RP2}), about which the frame member is sufficiently symmetric to permit the alternative use of the frame member in each of four attitudes such that the roller support structure 410 of which that frame member is a part can be caused to alternatively assume each of four configurations with respect to an arbitrarily designated material flow direction F_{M}. For instance, each of the first and second frame members 430 and 450 can be caused to assume a low-wall attitude or a high-wall attitude independent of the attitude of the opposite frame member. Accordingly, the roller conveyor module 400 can be configured, alternatively, in each of (i) a low-wall/low wall configuration, (ii) a high-wall/high-wall configuration, (iii) a left high-wall/right low-wall configuration and (iv) a left low-wall/right high-wall configuration. Moreover, with respect to the material flow direction F_{M} (e.g., from the first end 412 to the second end 414 of the roller support structure 410), each of the frame members 430 and 450 can alternatively assume the position of left and right frame members 418 and 420, thereby technically doubling the aforementioned four configurations possible to eight. However, because the first and second frame members 430 and 450 are indistinguishable in appearance, the designation of one frame member as the first frame member 430 and the other as the second frame member 450 is arbitrary at the outset and, therefore, there actually exist four distinct roller conveyor configurations into which the first and second frame members 430 and 450 can be incorporated. Accordingly, four illustrative configurations are depicted in the end views of FIGS. 2A through 2D in which the plane of the drawing sheet is orthogonal to the longitudinal axis A_{CL} of the roller support structure 410. Discussed later in this description are alternative embodiments in which each of the first and second frame members 430 and 450 includes a feature set including constituent features having symmetrical counterparts about at least one of two planes.

In order to facilitate clarity of description, each of various configurations that the roller support structure 410 can be caused to assume is described including the alternative attitudes each of frame members 430 and 450 is caused to assume in order to achieve that configuration. The designations of first and second ends and upper and lower edges of each frame member 430 and 450, while initially arbitrary, are held constant throughout the views of FIGS. 2A through 2D to facilitate comprehension of the orientation of each of frame members 430 and 450 in various roller-support structure configurations. Accordingly, the designations of frame-member ends and edges are set in this description with respect to a high-wall/high-wall configuration (FIG. 2A) in which the first frame member 430 is in the position of left frame member 418 and the second frame member 450 is in the position of right frame member 420 with respect to a is material flow direction F_{M} extending from the first end 412 of the roller support structure 410 and indicated as being into the plane of the drawing sheet by the vector symbol [symbol] .

The configuration of FIG. 2A may hereinafter be referred to as the “reference configuration.”

As shown in the reference configuration of FIG. 2A, the upper edge 434 of the first frame member wall 432 is disposed above the roller plane P_{R}, the lower edge 436 is below the roller plane P_{R} and the first end 442 of the first frame member 430 corresponds to the first end 412 of the roller support structure 410. Because the first and second frame members 430 and 450 are fabricated according to a common specification set, a high-wall/high-wall configuration is one in which the second frame member 450, when in the position of right frame member 420, is oriented such that the upper edge 454 is above the roller plane P_{R}, the lower edge 456 is below the roller plane P_{R} and the second end 464 corresponds to the first end 412 of the roller support structure 410 and is laterally opposite the first end 442 of the first frame member 430. The extension of the wall 432 of the left frame member 418 (i.e., first frame member 430) above the roller plane P_{R} by distance Aᵢ and the extension of the wall 452 of the right frame member 420 (i.e., second frame member 450) above the roller plane by distance A_{O} provides a material guide on each side of the roller conveyor module 400 to retain material on the rollers 480. Referring to the low-wall/low-wall configuration of FIG. 2B, the lower edges 436 and 456 of the first and second frame members 430 and 450 are disposed above the roller plane P_{R}. Moreover, the second end 444 of the first frame member 430 is laterally opposite the first end 462 of the second frame member 450 with the second end 444 and the first end 462 corresponding to the first end 412 of the roller support structure 410.

In the left high-wall/right low-wall configuration of FIG. 2C, the first frame member 430 is in the position of left frame member 418 with its upper edge 434 above the roller plane P_{R}, while the second frame member 450 is in the position of right frame member 420 with it lower edge 456 above the roller plane P_{R}. The first end 442 of the first frame member 430 is laterally opposite the first end 462 of the second frame member 450 and corresponds to the first end 412 of the roller support structure 410.

In FIG. 2D, a left low-wall/high right-wall configuration is shown. The lower edge 436 of the first (left) frame member 430 is above the roller plane P_{R} and the upper edge 454 of the second (right) frame member 450 is above the roller plane P_{R}. The second end 444 of the first frame member 430 is laterally opposite the second end 464 of the second frame member 450 and corresponds to the first end 412 of the roller support structure 410.

As previously indicated, each of the first and second frame members 430 and 450, in various embodiments, further includes a feature set arranged such that there exists at least one of (i) a first common plane P_{S1} orthogonal to the longitudinal axis of the frame member with respect to which first common plane P_{S1} each feature of the feature set on one side of the first common plane P_{S1} has a symmetrically situated counterpart on the opposite side of the first common plane P_{S1} and (ii) a second common plane P_{S2} passing between the upper and lower edges of the frame member with respect to which second common plane P_{S2} each feature of the feature set on one side of the second common plane P_{S2} has a symmetrically situated counterpart on the opposite side of the second common plane P_{S2}. In various illustrative alternative embodiments, the features of the feature set include (i) fastener-apertures adapted for receiving, for instance, bolts, screws, clips or rivets and (ii) windows for the passage of electromagnetic energy emitted from the emitter of a set of optical barrier apparatus, by way of non-limiting example.

Referring to the roller support structure 410 of FIGS. 1A and 1B, the first frame member 430 includes an illustrative feature set 447 and the second frame member 450 includes an illustrative feature set 467. Included in the feature set 447 is a subset of fastener apertures 447a adapted for the receipt of fasteners such as screws, bolts or rivets, for instance, as shown along the upper edge 434 of the first frame member 430. Similarly, included in the feature set 467, along the visible upper edge 454 of the second frame member 450, is a subset of fastener apertures 467a such as fastener apertures 447a. Obstructed in the view of FIG. 1A are fastener apertures 447a and 467a along, respectively, the lower edges 436 and 456 of the first and second frame members 430 and 450 that are symmetrically situated on the opposite side of the second common plane P_{S2}. The fastener apertures 447a and 467a in the upper and lower edges 434/454 and 436/456 are utilized, for example, in bolting together serially arranged roller conveyor modules, bolting on segments of fence (not shown) to increase the upward extension of a frame member wall or in fastening to the roller conveyor module 400 additional frame members to form a merge/divert region, by way of non-limiting example.

FIG. 1C shows the emitter/receiver unit 910 and reflector 920 of illustrative optical barrier apparatus 900. Lateral alignment of windows 447b and 467b in the cooperating first and second frame members 430 and 450 is facilitated by symmetry in the arrangement of windows 447b and 467b in, and the structural identity of, frame members 430 and 450. Optical barrier apparatus are secured to the frame members 430 and 450 by fasteners (e.g., screws or bolts) received through fastener apertures 447a and 467a adjacent windows 447b and 467b, See, for example, apertures 447a situated between windows 447b and the upper edge 434 of frame member 430 in FIG. 1B.

Shown in FIG. 1C is a cross member 490 used to selectively retain the first and second frame members 430 and 450 in fixed spatial relationship. In various embodiments, symmetrically arranged cross-member-fastener holes 447c and 467c facilitate the attachment of cross-members 490 to alternatively secure frame members 430 and 450 in any of a high-wall/high-wall, a low-wall/low-wall and a high-wall/low-wall configuration without having to bore additional holes in frame members 430 and 450. In many embodiments, as indicated by the embodiment illustrated in FIG. 1C, cross-members 490 extend laterally between rollers 480 so as to remain out of the path of material travel along the rollers 480 in each of various configurations.

Another symmetrical feature in evidence among various embodiments is the general structural cross-sectional geometry of the frame members 430 and 450. Reference to FIGS. 1B and 1C facilitates an appreciation that the basic structure of each of frame members 430 and 450 is generally symmetrical about the first and second planes P_{S1} and P_{S2}. Additional, non-limiting examples of features relative to which there may exist symmetrical counterparts on the opposite side of at least one of two planes are further described in association with curved embodiments.

In various versions, frame members 430 and 450 include multiple (i.e., two or more) “symmetrical zones” within each of which zones various features exhibit symmetry about a zone plane orthogonal to the longitudinal axis of the frame member and bifurcating the zone. The illustrative frame member 430 includes two symmetrical zones: a first zone extending between the first end 442 of the frame member 430 and the plane P_{S1} and a second zone extending between the plane P_{S1} and the second end 444 of the frame member 430. The first zone includes features within the feature set 447 that exhibit symmetry about a first zone plane P_{SZ1} and the second zone includes features within the feature set 447 that exhibit symmetry about a second zone plane P_{SZ2}. It will be appreciated that “zoning” in the general manner depicted enables the fabrication of long frame member pieces that include numerous zones. These long multi-zone pieces can then be cut to form lengths including a desired, lesser whole number of zones for use as frame members 430 and 450 including laterally aligned features as previously described.

### Illustrative Embodiments of Spur-Bracket Assembly Components

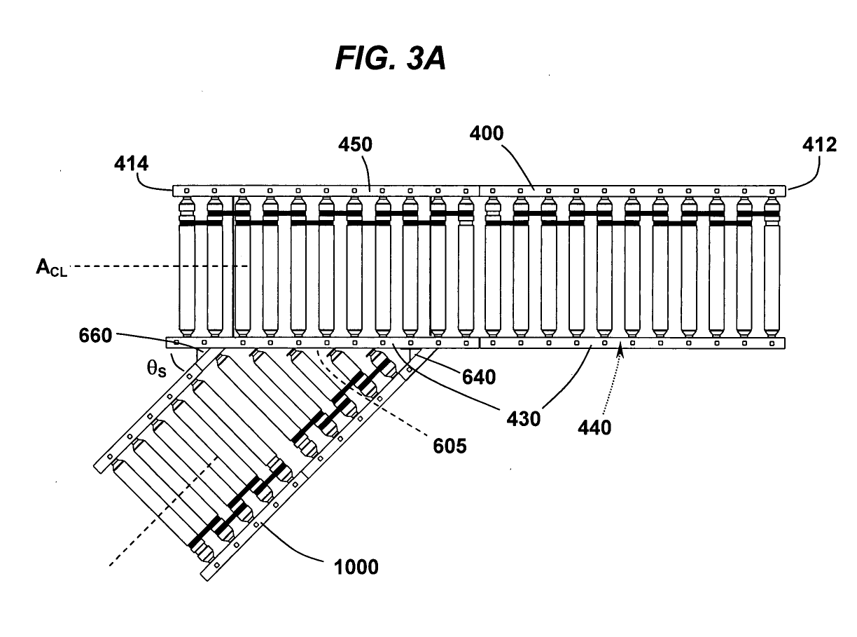

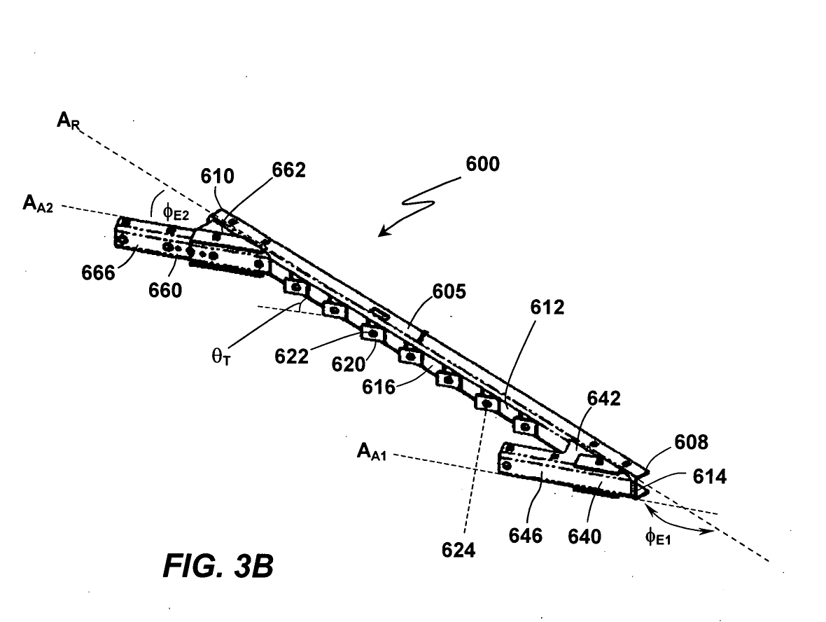

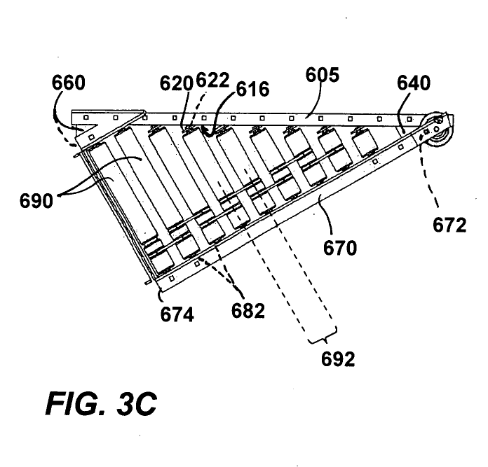

As discussed briefly in the background section of the specification, conventional roller conveyors are variously reconfigured by the wholesale replacement of roller conveyor sections with specially configured roller conveyor modules exhibiting the desired configuration (e.g., y-shaped or T-shaped). The reconfigurability of various versions of roller conveyor modules within the scope of the invention obviates the need for wholesale replacement of roller conveyor sections to enable merging and diversion of materials onto and from the portion of roller conveyor to be modified. Referring to FIGS. 3A through 3C, various embodiments of an alternatively configurable roller conveyor module 400 include at least one set of spur-bracket assembly components for facilitating the interconnection at a spur angle θ_{S} of the alternatively configurable roller conveyor module 400 with another roller conveyor module 1000. The roller conveyor 1000 can be one of (i) a merging conveyor module from which material is transferred to the roller conveyor module 400 and (ii) a diverting conveyor module to which material is transferred from the roller conveyor module 400.

Referring to FIG. 3B, an illustrative spur bracket-assembly 600 includes an elongated rail 605 extending longitudinally along a rail axis A_{R} and having first and second longitudinally opposed ends 608 and 610. A wall 612 with an inside face 614 and an outside face 616 extends between the first and second ends 608 and 610. Depending from the wall 612 is a set of roller-supporting tabs 620, each tab 620 including a roller-mounting aperture 622 therethrough and diverging outwardly from the outside face 616 at a tab angle θ_{T} corresponding to the spur angle θ_{S}. The roller-mounting apertures 622 of the roller-supporting tabs 620 are spaced apart so as to define roller axes 624 separated in accordance with a predetermined roller spacing.

The elongated rail 610 is adapted for fastening over at least a portion of the outer face 440 or 460 of one of the first and second frame members 430 and 450 included in the assembled roller conveyor module 400 in a low wall attitude such that the wall 432 or 452 of the frame member 430 or 450 to which the elongated rail 605 is fastened does not constitute an obstruction to material flow between the roller conveyor module 400 and the merging or diverting roller conveyor module 1000.

A first, outside bracket 640 includes a base member 642 and a first arm 646 extending from the base member 642. The base member 642 is adapted for fastening to the elongated rail 605 such that, when the rail 605 is attached to one of the first and second frame members 430 and 450 of the roller conveyor module 400, and the outside bracket 640 is attached to the rail 605, the first arm 646 extends along a first-arm axis A_{A1} defining, with the longitudinal axis of the frame member 430 or 450, and the rail axis A_{R}, an angle φ_{E1} exterior to the first arm 646 and the frame member 430 or 450 greater than 90° and supplementary to the spur angle θ_{S}.

A second, inside bracket 660 includes a base member 662 and a second arm 666 extending from the base member 662. The base member 662 is adapted for fastening to the elongated rail 605 such that, when the rail 605 is attached to one of the first and second frame members 430 and 450 of the roller conveyor module 400, and the inside bracket 660 is attached to the rail 605, the second arm 666 extends along a second-arm axis A_{A2} defining, with the longitudinal axis of the frame member 430 or 450, and the rail axis A_{R}, an angle φ_{E2} exterior to the second arm 666 and the frame member 430 or 450 less than 90° and corresponding to the spur angle θ_{S}. Typically, the first-arm and second arm axes A_{A1} and A_{A2} are parallel to one another and form an angle with the rail axis A_{R} equal to the spur angle θ_{S}. In various embodiments, the assembly 600 is substantially symmetrical about a center plane (not shown) passing through the inside and outside faces 614 and 616 and the first and second ends 608 and 610 of the rail wall 612 in order to facilitate its use in any of (i) a right side divert, (ii) a right side merge, (iii) a left side divert and (iv) a left side merge application.

Referring to FIG. 3C, an embodiment further includes a bracket extender 670 adapted for coupling with the outside bracket 640. The extender 670 has first and second ends 672 and 674 and includes a set of roller-mounting apertures 682 disposed between the first and second ends 672 and 674. The set of roller-mounting apertures 682 includes a roller-mounting aperture 682 corresponding to each roller-mounting aperture 622 included through a roller-supporting tab 620 depending from the elongated rail 605. Each roller-mounting aperture 682 of the bracket extender 670 is aligned with the counterpart of that roller-mounting aperture 682 included through a roller-supporting tab 620 for the mounting of a roller 690. As shown in FIG. 3C, each roller 690 adapted for support by the elongated rail 605 and the bracket extender 670 is of a length appropriate to the position of the tab 620 by which that roller 690 is to be supported. Among the rollers 690 adapted for support between the bracket extender 670 and the elongated rail 605, the roller 690 adapted for support by the tab 620 closest to the outside bracket 640 is the shortest and the roller 690 adapted for support by the tab 620 closest to the inside bracket 660 is the longest. Each roller 690 adapted for support between the bracket extender 670 and the elongated rail 605, when so supported, is rotatable about a roller axis 692 extending at an angle with respect to the rail axis A_{R}, corresponding to the spur angle θ_{S}. The merging or diverting roller conveyor module 1000 is then secured to the inside bracket 660 and the bracket extender 670.

### Curved Embodiments of an Alternatively Configurable Roller Conveyor Module

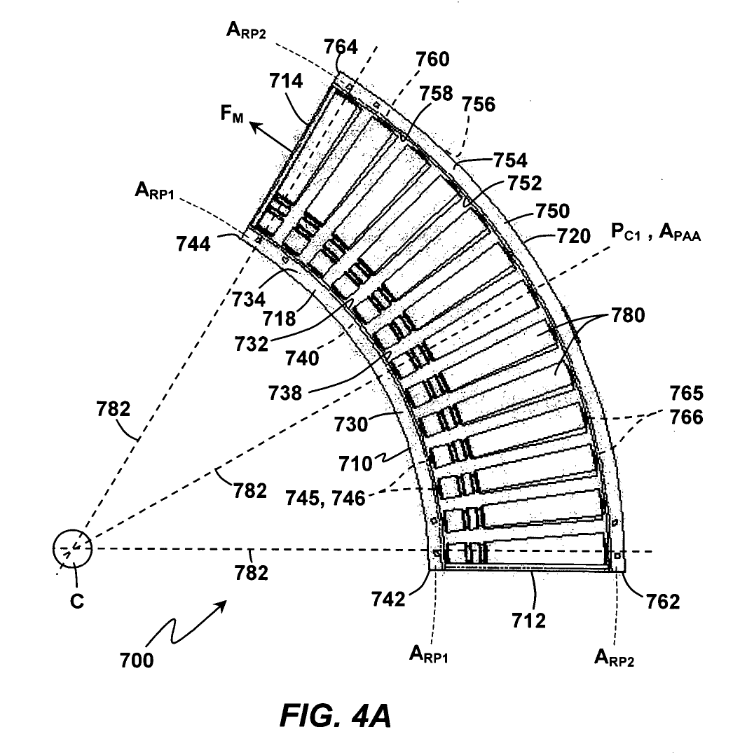

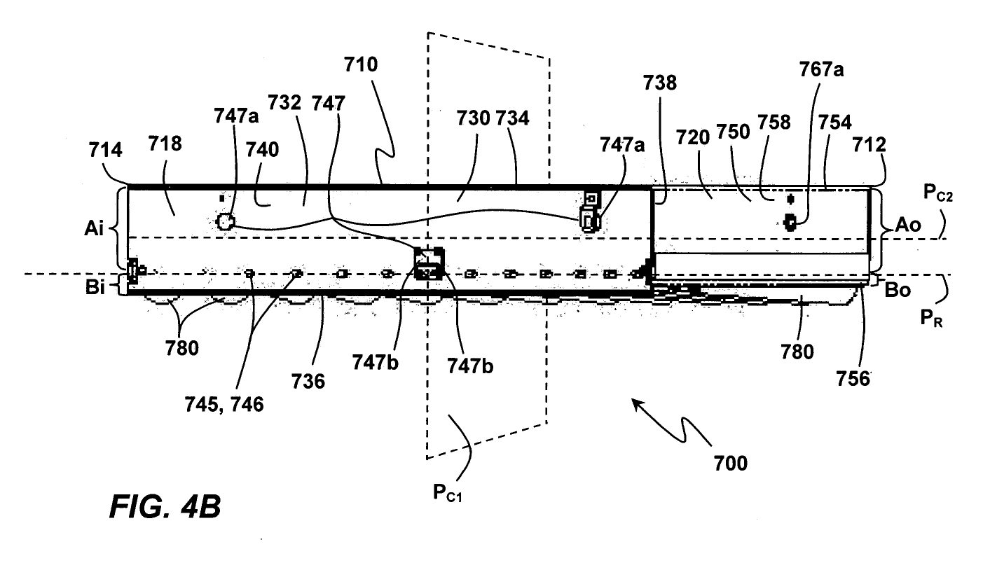

Referring to FIGS. 4A and 4B, an alternatively configurable curved roller conveyor module 700 includes a roller support structure 710 having first and second ends 712 and 714 and inner and outer radially spaced, arcuate frame members 730 and 750 concentric about a center C wherein the inner frame member 730 traces an arc of lesser radius than the arc traced by the outer frame member 750. Extending between, and supported by, the radially spaced frame members 730 and 750 is a plurality of rollers 780, each of which rollers 780 rotates about a roller axis 782 radially emanating from the center C and diverging therefrom with respect to roller axes 782 of other rollers 780 among the plurality. Moreover, the roller axes 782 of the rollers 780 supported by the support structure 710 lie along a roller plane P_{R}.

The inner frame member 730 has an arcuate wall 732 having upper and lower edges 734 and 736, predetermined inner and outer faces 738 and 740 and first and second arcuately opposed ends 742 and 744. Similarly, the outer frame member 750 has an arcuate wall 752 including an upper edge 754 and a lower edge 756, predetermined inner and outer faces 758 and 760 and first and second arcuately opposed ends 762 and 764. Although the roller conveyor module 700 is alternatively configurable, in each assembled configuration, at least a portion of the inner face 738 of the inner frame 730 member faces the inner face 758 of the outer frame member 750.

In various embodiments, the inner and outer arcuate frame members 730 and 750 include, respectively, first and second roller-mounting aperture sets 745 and 765 including roller-mounting apertures 746 and 766 arranged to facilitate the radial emanation of each of the rollers 780 supported between the inner and outer frame members 730 and 750 such that the roller plane P_{R} along which the roller axes 782 lie passes through each of the roller-mounting apertures 746 and 766 in, respectively, each of the first and second aperture sets 745 and 765. The roller plane P_{R} passing through each of the arcuate frame members 730 and 750 typically passes through locations corresponding to the geometric centers of round, hexagonal or other regular polygonal roller-mounting apertures 746 and 766. In any event, the arrangement of the roller-mounting apertures 746 and 766 along each of, respectively, arcuate frame members 730 and 750 is such that there exists an arcuate roller-plane axis passing through the roller-mounting apertures in the roller aperture set of the arcuate wall of each frame member 730 and 750 that corresponds to the position of intersection, in an assembled curved roller support structure 710, of the roller plane P_{R} and the arcuate frame wall. These arcuate roller-plane axes are identified in the drawings as A_{RP1} and A_{RP2} passing through, respectively, the first roller aperture set 745 in the arcuate wall 732 of the inner frame member 730 and the second roller aperture set 765 in the arcuate wall 752 of the outer frame member 750.

As shown in FIG. 4B, the first aperture set 745 of the inner arcuate frame member 730 is further arranged such that the first arcuate roller-plane axis A_{RP1} is displaced by a first distance Aᵢ from the upper edge 734 of the arcuate wall 732 and by a second distance Bᵢ from the lower edge 736 of the arcuate frame member wall 732. The second distance Bᵢ is lesser in magnitude than the first distance Aᵢ such that, in any particular assembled configuration, the first roller plane axis A_{RP1} is closer to the lower edge 736 of the inner frame member 730 than to the upper edge 734. Analogously, the second aperture set 765 of the outer arcuate frame member 750 is arranged such that the second arcuate roller-plane axis A_{RP2} is displaced by a first distance A_{O} from the upper edge 754 of the arcuate frame member wall 752 and by a second distance B_{O} from the lower edge 756 of the arcuate frame member wall 752 with the second distance B_{O} being lesser in magnitude than the first distance A_{O}. In various embodiments, Aᵢ and A_{O} are of equal magnitude and Bᵢ and B_{O} are of equal magnitude.

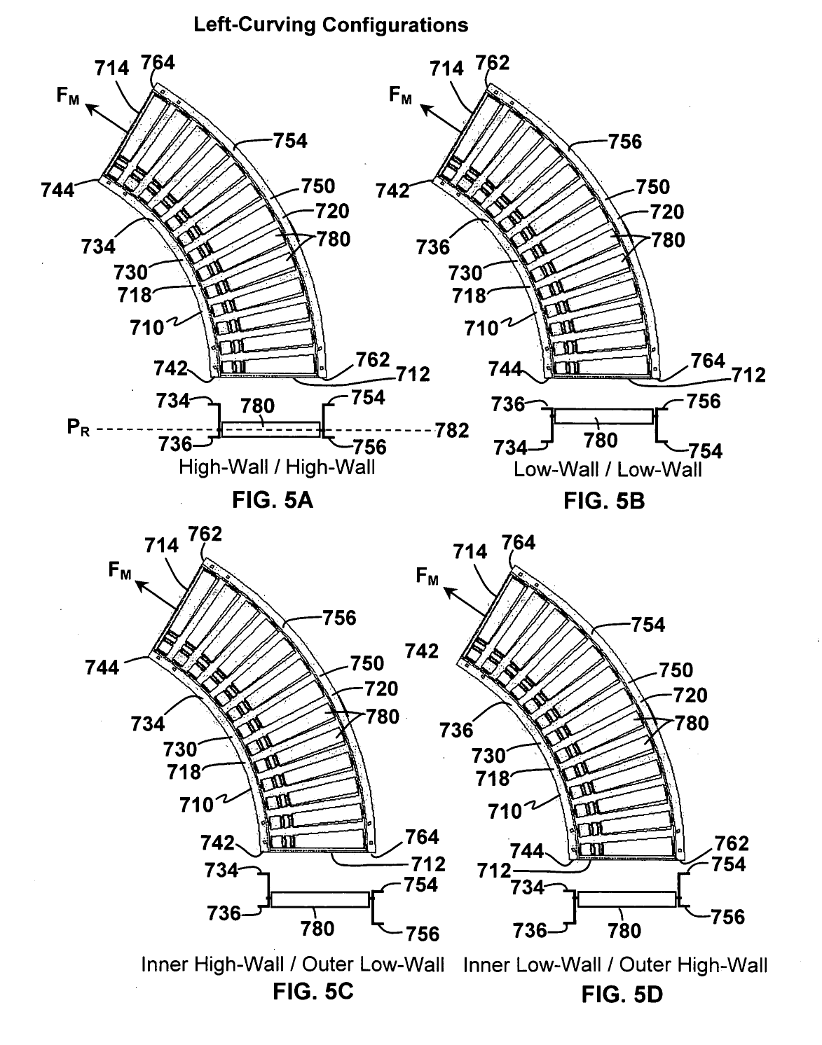

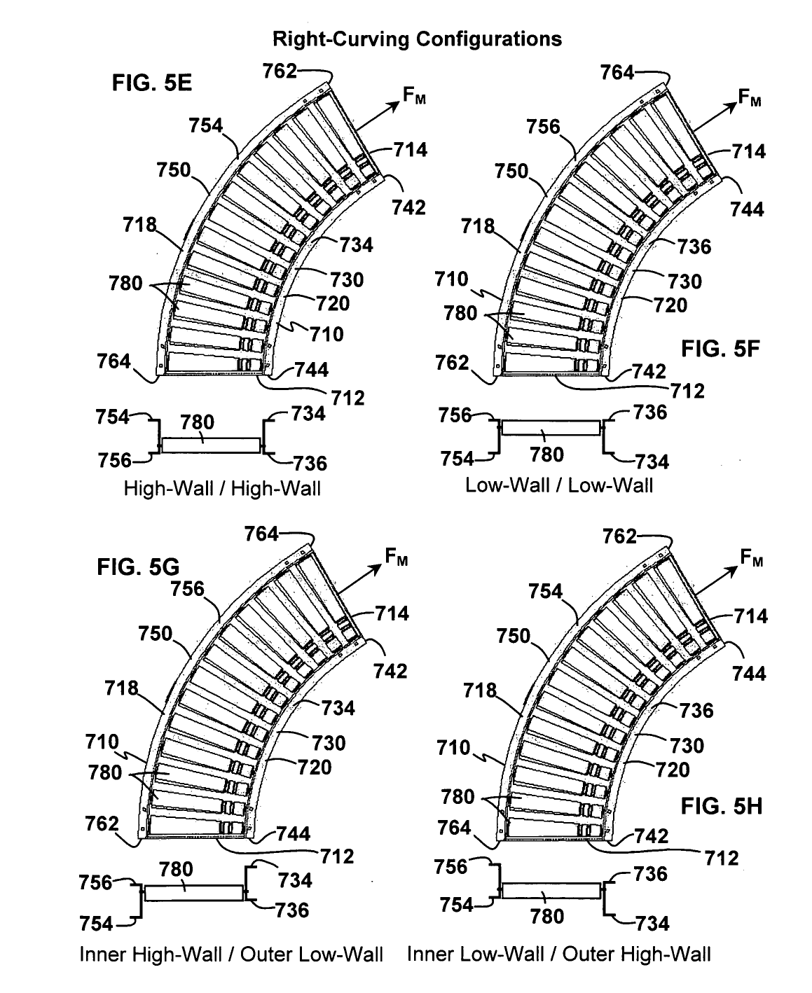

As shown in FIGS. 4A and 4B, relative to each of the inner and outer frame members 730 and 750, there exists a plane P_{C1} passing through a mid-point along the arc-length of the frame wall, and orthogonal to the arcuate roller-plane axis (i.e., each of A_{RP1}, and A_{RP2}), about which the frame member is sufficiently symmetric to permit the alternative use of the frame member in each of four attitudes such that the roller support structure 710 of which that frame member is a part can be caused to alternatively assume each of eight configurations with respect to a material-flow direction F_{M}. For instance, each of the inner and outer frame members 730 and 750 can be caused to assume a low-wall attitude or a high-wall attitude independent of the attitude of the opposite frame member. Accordingly, the roller conveyor module 700 can be configured, alternatively, in each of (i) a low-wall/low wall configuration, (ii) a high-wall/high-wall configuration, (iii) an inner low-wall/outer high-wall configuration and (iv) an inner high-wall/outer low wall configuration. Moreover, with respect to a material flow direction F_{M} (e.g., from the first end 712 to the second end 714 of the roller support structure 710), the frame members 730 and 750 can be arranged to curve to the left or to the right, thereby doubling the aforementioned four configurations possible for each direction to eight. Eight illustrative configurations are depicted in FIGS. 5A through 5H as viewed downwardly from above the roller plane P_{R}. Discussed later in this description are alternative embodiments in which the inner frame member 730 includes a first feature set 747 including constituent features (e.g., 747a, b, c, etc.) having symmetrical counterparts about at least one of two planes and in which the outer frame member 750 includes a second feature set 767 including constituent features (e.g., 767a, b, c, etc.) having symmetrical counterparts about at least one of the two aforementioned planes.

As examination of FIGS. 5A through 5H will reveal, with respect to material flow direction F_{M} as viewed from above, each of the inner and outer frame members 730 and 750 alternatively assumes the positions of left side and right side frame members 718 and 720. More specifically, in the left-curving configurations of FIGS. 5A through 5D, the inner frame member 730 is in the position of left side frame member 718 and the outer frame member 750 is in the position of right side frame member 720. Conversely, in the right-curving conveyor module configurations of FIGS. 5E through 5H, the outer frame member 750 assumes the position of left side frame member 718 while the inner frame member 730 functions as the right side frame member 720.

For purposes of clarity of description, each of various configurations that the roller support structure 710 can be caused to assume is described including the alternative attitudes each of frame members 730 and 750 is caused to assume in order to achieve that configuration. The designations of first and second ends and upper and lower edges of each frame member 730 and 750, while initially arbitrary, are held constant throughout the views of FIGS. 5A through 5H to facilitate comprehension of the orientation of each of frame members 730 and 750 in various roller-support structure configurations. Accordingly, the designations of frame-member ends and edges are set in this description with respect to the left-curving, high-wall/high-wall configuration shown in FIG. 5A, which configuration may hereinafter be referred to as the “reference configuration.”

In the high-wall/high wall, left-curving reference configuration of FIG. 5A, each of the inner and outer frame members 730 and 750 is secured concentrically (i.e., in concentric alignment or concentric relation) with the other of the inner and outer frame members 730 and 750. The upper edges 734 and 754 of the frame members 730 and 750 are disposed above the roller plane P_{R} and the first end 742 of the inner frame member 730 is laterally opposite the first end 762 of the outer frame member 750. In addition, the first ends 742 and 762 of, respectively, the inner and outer frame members 730 and 750 correspond to the first end 712 of the roller-support structure 710. Moreover, as shown in the schematic first end view portion of FIG. 5A, the extension of the arcuate wall 732 of the inner frame member 730 above the roller plane P_{R} by distance Aᵢ and the extension of arcuate wall 752 of the outer frame member 750 above the roller plane by distance A_{O} provides a material guide on each side of the roller conveyor module 700 to retain material on the rollers 780.

Referring to the high-wall/high-wall, right-curving configuration of FIG. 5E, the upper edges 734 and 754 of the inner and outer frame members 730 and 750 are disposed above the roller plane P_{R}. Moreover, just as in the left-curving, high-wall/high-wall configuration, the first ends 742 and 762 of the inner and outer frame members 730 and 750 are laterally opposite one another. However, in the right-curving, high-wall/high-wall configuration of FIG. 5E, the first ends 742 and 762 of the inner and outer frame members 730 and 750 correspond to the second end 714 of the roller-support structure 710 instead of corresponding to the first end 712 of the roller-support structure 710 as in FIG. 5A. Accordingly, material flowing through the curved roller conveyor module 700 in the material flow direction F_{M} indicated will “encounter” the second ends 744 and 764 of the first and second frame members 730 and 750 prior to encountering the first ends 742 and 762 of the first and second frame members 730 and 750 corresponding to the second end 714 of the roller-support structure 710.

Referring to the low-wall/low-wall, left-curving configuration of FIG. 5B, the lower edges 736 and 756 of the inner and outer frame members are disposed above the roller plane P_{R} and the first end 742 of the inner frame member 730 is laterally opposite the first end 762 of the second frame member 750. However, in a left-curving low-wall/low-wall configuration, the first ends 742 and 762 correspond to the second end 714 of the roller-support structure 710. In contrast, consider the low-wall/low-wall, right-curving configuration of FIG. 5F in which the lower edges 736 and 756 are disposed above the roller plane P_{R}, but the second ends 744 and 764 of the inner and outer frame members 730 and 750 correspond to the second end 714 of the roller-support structure 710.

In FIG. 5C, a left-curving, inner high-wall/outer low-wall configuration is shown. The inner frame member 730 is in the position of left side frame member 718 with its upper edge 734 above the roller plane P_{R}, while the outer frame member 750 is in the position of right side frame member with its lower edge 756 above the roller plane P_{R}. The first end 742 of the inner frame member 730 is laterally opposite the second end 764 of the outer frame member 750 and corresponds to the first end 712 of the roller support structure 710. Consider, in contrast, the right-curving, inner high-wall/outer low-wall configuration of FIG. 5G. In FIG. 5G, the inner frame member 730 is in the position of right side frame member 720 with its upper edge 734 above the roller plane P_{R}, while the outer frame member 750 is in the position of left side frame member with its lower edge 756 above the roller plane P_{R}. Moreover, in the right-curving configuration of FIG. 5G, the first end 762 of the outer frame member 750 is laterally opposite the second end 744 of the inner frame member 730 and corresponds to the first end 712 of the roller support structure 710.

In the left-curving, inner low wall/outer high-wall configuration of FIG. 5D, the lower edge 736 of the inner (left) frame member 730 is above the roller plane P_{R} and the upper edge 754 of the outer (right) frame member 750 is above the roller plane P_{R}. The second end 744 of the inner frame member 730 is laterally opposite the first end 762 of the outer frame member 750 and corresponds to the first end 712 of the roller-support structure 710. In the “mirror image,” right-curving, inner low-wall/outer high-wall configuration of FIG. 5H, the inner frame member 730 is in the position of right side frame member 720 with the lower edge 736 thereof above the roller plane P_{R} and the outer frame member 750 is in the position of left side frame member 718 with its upper edge 754 above the roller plane P_{R}. The first end 742 of the inner frame member 730 is laterally opposite the second end 764 of the outer frame member 750 and corresponds to the first end 712 of the roller support structure 710.

As previously indicated, various embodiments of an alternatively configurable curved roller conveyor module 700 are such that the inner frame member 730 includes a first feature set 747 including constituent features (e.g., 747a, b, c, etc.) having symmetrical counterparts about at least one of two planes and in which the outer frame member 750 includes a second feature set 767 including constituent features (e.g., 767a, b, c, etc.) having symmetrical counterparts about at least one of the two aforementioned planes. This aspect is explained with primary reference to FIGS. 4A and 4B. Between these two views, only the first feature set 747 is visible; logical and analytical extension on the reader's part being relied upon to convey the understanding that the second feature set 767 of the outer frame member 750 is, in various embodiments, analogously arranged. Referring to FIG. 4B, there exists in space a plane P_{C1} that passes midway between the first and second ends 712 and 714 of the roller support structure 710. Moreover, plane P_{C1} is orthogonal to each of axes A_{RP1} and A_{RP2}. The inner frame member 730 includes a first feature set 747 including optical barrier apertures 747a through which a beam of electromagnetic energy can pass between an emitter and a detector and, on each side of plane P_{C1}, one half of a cross member bracket 747b used as a point of attachment between a cross member (not shown) and the inner frame member 730. In various embodiments, such cross members are used to selectively secure to one another, and maintain the radial spacing between, the inner and outer arcuate frame members 730 and 750. The constituent features 747a and 747b are merely illustrative in nature; persons of ordinary skill in the art will appreciate that other constituent features may be properly included in the first feature set 747. For instance, in alternative embodiments, the feature sets 747 and 767 include fastener holes such as bolt and screw holes, brackets, braces, and detents, by way of non-limiting example. Each of illustrative features 747a and 747b has a symmetrical counterpart on the opposite side of the plane P_{C1}. In alternative embodiments that are not shown, the first and second feature sets 747 and 767 include features having symmetrical counterparts on the opposite of the plane P_{C2} shown in FIG. 4B. Plane P_{C2} is parallel to the roller plane P_{R} and is equi-spaced between the upper and lower edges 734 and 736 of the inner frame member 730. Because FIG. 4B represents a special case in which Ai=Ao and Bi=Bo, and because the configuration in FIG. 4B is high-wall/high-wall, plane P_{C2} is also equi-spaced between the upper and lower edges 754 and 756 of the outer frame member 750. In other circumstances, it will be appreciated, a separate plane of feature-set symmetry (other than P_{C2}) exists between the upper and lower edges 754 and 756 of the outer frame member 750 with respect to which features of the second feature set 767 may be referred to as having symmetrical counterparts.

Symmetry of features within the feature set 747 about at least one of planes P_{C1} and P_{C2} facilitates the assumption of various attitudes of the inner frame member 730, such as the attitudes previously described and explained in connection with FIGS. 5A through 5H, while having accessible in a desired location with respect, for example, to one of the first and second ends 712 and 714 of the roller-support structure 710, a desired feature. By way of very specific, illustrative example, it may be desirable, regardless of the attitude of the inner frame member 730 to have accessible an optical barrier aperture such as 747a five inches in from the first end 712 of the roller-support structure 710 along the inner frame member 730. Accordingly, the feature set 747 would be caused to include an optical barrier aperture 747a five inches in from each of the first and second ends 742 and 744 of the inner frame member 730. Moreover, in order to facilitate lateral alignment of the optical barrier apertures 747a in the first frame member 730 with corresponding optical barrier apertures in the outer frame member 750, the outer frame member 750 would include optical barrier apertures 767a situated inwardly from each the first and second ends 762 and 764 by an appropriate arc-length distance greater than five inches.

It is to be understood that the feature sets 747 and 767 may be defined such that the constituent features included therein have symmetrical counterparts about one, or both, of planes P_{C1} and P_{C2} (or an analogous plane for the second feature set 767). Moreover, separate sets or subsets of feature sets 747 and 767 may be defined that having differing symmetric characteristics with respect to planes P_{C1} and P_{C2}. For instance, one set of features may include features having symmetrical counterparts about two planes (e.g., P_{C1} and P_{C2}) while another set of features may include features having symmetrical counterparts about only a single plane (e.g., P_{C1} or P_{C2}). For instance, in FIG. 4B, the roller-mounting apertures 746 can be characterized as belonging to a feature set including features having symmetrical counterparts only with respect to plane P_{C1}.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact construction, implementations and versions shown and described.

What is claimed is:

1. An alternatively configurable roller conveyor module comprising:
a roller support structure including left and right elongated frame members fabricated in accordance with a common specification set, each of the left and right frame members having, as determined by the specification set, upper and lower edges, a wall including pre-designated inner and outer faces, and first and second longitudinally opposed ends, the left and right frame members being retained in parallel for extension along a longitudinal axis; and
a plurality of rollers supported by, and extending between, the frame members for rotational motion about roller axes extending along a roller plane and perpendicular to the longitudinal axis, wherein
(i) each of the left and right frame members further includes a roller-mounting aperture set including roller-mounting apertures extending longitudinally between the first and second ends of the frame member such that a single roller-plane axis passes through each of the roller-mounting apertures in the roller-mounting aperture set, the roller-plane axis being displaced by a first distance from the upper edge of the frame member and by a second distance, lesser in magnitude than the first distance, from the lower edge of the frame member such that the roller-plane axis is closer to the lower edge than to the upper edge of the frame member,
(ii) the roller-plane axes of the left and right frame members correspond to the intersection of the roller plane and the walls of the left and right frame members, and
(iii) each of the left and right frame members includes a feature set that exhibits sufficient symmetry about at least one of (a) a first plane orthogonal to the roller plane axis of the frame member and (b) a second plane passing between the upper and lower edges of the frame member such that the left and right frame members are adapted for alternative assembly in the roller conveyor module, with at least a portion of the inner face of the left frame member facing at least a portion of the inner face of the right frame member such that there exists lateral alignment among features in the feature set of the left frame member with like features in the feature set of the right frame member, in at least two of (i) a high-wall/high-wall configuration; (ii) a low-wall/low-wall configuration and (iii) a high-wall/low-wall configuration, wherein
(a) a high-wall/high-wall configuration is one in which the upper edge of each frame member is disposed above the roller plane, the lower edge of each frame member is disposed below the roller plane and the first end of each frame member is laterally opposite the second end of the other frame member;
(b) a low-wall/low-wall configuration is one in which the upper edge of each frame member is disposed below the roller plane, the lower edge of each frame member is disposed above the roller plane and the first end of one frame member is laterally opposite the second end of the other frame member; and
(c) a high-wall/low-wall configuration is one in which the upper edge of one frame is member disposed below the roller plane, the upper edge of the other frame member is disposed above the roller plane and the first end of each frame member is laterally opposite the first end of the other frame member.

2. The alternatively configurable roller conveyor module of claim 1 wherein the feature set of each of the left and right frame members comprises at least one of
(i) fastener apertures;
(ii) apertures for the receipt of optical barrier apparatus;
(iii) apertures for facilitating the passage of electromagnetic energy emitted from an emitter for detection by a receiver of cooperating optical barrier apparatus;
(iv) the cross sectional geometry of the frame member; and
(v) the roller-mounting apertures.

3. The alternatively configurable roller conveyor module of claim 2 wherein the feature set exhibits sufficient symmetry about each of the first and second planes such that the left and right frame members are adapted for alternative assembly into each of (i) a high-wall/high-wall configuration; (ii) a low-wall/low-wall configuration and (iii) a high-wall/low-wall configuration.

4. The alternatively configurable roller conveyor module of claim 1 wherein the feature set exhibits sufficient symmetry about each of the first and second planes such that the left and right frame members are adapted for alternative assembly into each of (i) a high-wall/high-wall configuration; (ii) a low-wall/low-wall configuration and (iii) a high-wall/low-wall configuration.

5. A roller conveyor module selectively configurable into alternative configurations and comprising:
a roller support structure having first and second ends and left and right spaced apart arcuate frame members secured concentrically about a center point;
a plurality of rollers rotatably supported between the left and right frame members for rotational motion about roller axes extending radially along a roller plane and converging toward the center point;
an arcuate inner frame member including an arcuate wall with upper and lower edges, inner and outer faces and first and second arcuately opposed ends, the inner frame member having a first roller-mounting aperture set including roller mounting apertures arranged such that there exists a first arcuate roller-plane axis passing through each of the roller-mounting apertures in the first roller-mounting aperture set and such that the first roller-plane axis is closer to the lower edge than to the upper edge of the inner frame member; and
an arcuate outer frame member including an arcuate wall with upper and lower edges, inner and outer faces and first and second arcuately opposed ends, the outer frame member being defined by a larger radius of curvature than the inner frame member and having a second roller-mounting aperture set including roller mounting apertures arranged such that there exists a second arcuate roller-plane axis passing through each of the roller-mounting apertures in the second roller-mounting aperture set and such that the second roller-plane axis is closer to the lower edge than to the upper edge of the outer frame member, wherein
(i) the first roller-plane axis and the second roller-plane axis correspond to the intersection of the roller plane with the arcuate walls of, respectively, the inner frame member and the outer frame member in an assembled configuration, and
(ii) each of the inner and outer frame members includes a feature set that exhibits sufficient symmetry about at least one of (a) a first plane orthogonal to the roller plane axis of the frame member and (b) a second plane passing between the upper and lower edges of the frame member such that the inner and outer frame members are adapted for cooperative assembly into at least one alternative roller-conveyor-module configuration selected from among each of the following two configuration sets wherein each configuration is directionally defined as left-curving or right-curving with reference to an arbitrary, pre-designated material flow direction and such that there exists lateral alignment among features in the feature set of the inner frame member with like features in the feature set of the outer frame member:
(a) a first configuration set wherein the inner and outer frame members are secured concentrically to one another with the first end of the inner frame member laterally opposite to the first end of the outer frame member, wherein the first configuration set comprises:
(i) an inner high-wall/outer high-wall, left-curving configuration in which the upper edge of each frame member is disposed above the roller plane, the lower edge of each frame member is disposed below the roller plane and the first ends of the inner and outer frame members correspond to the first end of the roller support structure;
(ii) an inner low-wall/outer low-wall, left-curving configuration in which the lower edge of each frame member is disposed above the roller plane, the upper edge of each frame member is disposed below the roller plane and the first ends of the inner and outer frame members correspond to the second end of the roller support structure;
(iii) an inner high-wall/outer high-wall, right-curving configuration in which the upper edge of each frame member is disposed above the roller plane, the lower edge of each frame member is disposed below the roller plane and the first ends of the inner and outer frame members correspond to the second end of the roller support structure; and
(iv) an inner low-wall/outer low-wall, right-curving configuration in which the lower edge of each frame member is disposed above the roller plane, the upper edge of each frame member is disposed below the roller plane and the first ends of the inner and outer frame members correspond to the first end of the roller support structure; and
(b) a second configuration set wherein the inner and outer frame members are secured concentrically to one another with the first end of the inner frame member laterally opposite to the second end of the outer frame member, wherein the second configuration set comprises:
(i) an inner high-wall/outer low-wall, left-curving configuration in which the upper edge of the inner frame member is disposed above the roller plane, the lower edge of outer frame member is disposed above the roller plane and the first end of the inner frame member and the second end of the outer frame member correspond to the first end of the roller support structure;
(ii) an inner low-wall/outer high-wall, left-curving configuration in which the lower edge of the inner frame member is disposed above the roller plane, the upper edge of outer frame member is disposed above the roller plane and the first end of the inner frame member and the second end of the outer frame member correspond to the second end of the roller support structure;
(iii) an inner high-wall/outer low-wall, right-curving configuration in which the upper edge of the inner frame member is disposed above the roller plane, the lower edge of outer frame member is disposed above the roller plane and the first end of the outer frame member and the second end of the inner frame member correspond to the first end of the roller support structure; and
(iv) an inner low-wall/outer high-wall, right-curving configuration in which the lower edge of the inner frame member is disposed above the roller plane, the upper edge of outer frame member is disposed above the roller plane and the first end of the inner frame member and the second end of the outer frame member correspond to the first end of the roller support structure.

6. The alternatively configurable roller conveyor module of claim 5 wherein the feature set of each of the inner and outer frame members comprises at least one of
(i) fastener apertures;
(ii) apertures for the receipt of optical barrier apparatus;
(iii) apertures for facilitating the passage of electromagnetic energy emitted from an emitter for detection by a receiver of cooperating optical barrier apparatus;
(iv) the cross sectional geometry of the frame member; and
(v) the roller-mounting apertures.

7. A roller-conveyor-module framing kit adapted for incorporation in an assembled roller conveyor module including left and right side laterally spaced frame members extending along a longitudinal axis and adapted for supporting a plurality of rollers between the frame members for rotational motion about roller axes extending (i) along a roller plane and (ii) orthogonal to the longitudinal axis, the framing kit comprising:
first and second frame members fabricated in accordance with a common set of specifications, each of the first and second frame members extending along a longitudinal frame-member axis and, as determined by the specifications set, having an upper edge and a lower edge, a wall including pre-designated inner and outer faces and first and second longitudinally opposed ends, each of the first and second frame members further having a feature set including features arranged such that there exists at least one of (i) a first common plane orthogonal to the longitudinal axis of the frame member with respect to which first common plane each feature of a first selected subset of features on one side of the first common plane has a symmetrically situated counterpart on the opposite side of the first common plane and (ii) a second common plane extending between the upper and lower edges of the frame member with respect to which second common plane each feature of a second selected subset of features on one side of the second common plane has a symmetrically situated counterpart on the opposite side of the second common plane.

8. The framing kit of claim 7 wherein each feature of the feature set has a symmetrically situated counterpart on the opposite side of each of the first and second common planes such that each frame member has the capacity, without modification, to alternatively assume the position of one of (i) the left frame member and (ii) the right frame member in the assembled roller conveyor module with the inner face of the first frame member facing the inner face of the second frame member.

9. The framing kit of claim 8 wherein each of the first and second frame members includes a roller-mounting aperture set including roller-mounting apertures extending longitudinally on one side of the second common plane and arranged such that a single roller-plane axis passes through each of the apertures in the roller-mounting aperture set, the roller-plane axis being displaced by a first distance from the upper edge of the frame member and by a second distance, lesser in magnitude than the first distance, from the lower edge of the frame member such that the roller-plane axis is closer to the lower edge than to the upper edge and wherein the roller-mounting aperture set of each of the first and second frame members is a feature set for which each roller-mounting aperture of a selected subset of roller-mounting apertures on one side of the first common plane has a symmetrically situated counterpart on the opposite side of the first common plane.

10. The framing kit of claim 9 wherein the first and second frame members can be alternatively incorporated into an assembled roller conveyor module, with at least a portion of the inner face of one frame member facing at least a portion of the inner face of the other frame member, in at least two of (i) a high-wall/high-wall configuration; (ii) a low-wall/low-wall configuration and a (iii) high-wall/low-wall configuration, and wherein:
(a) a high-wall/high-wall configuration is one in which each of the first and second frame members is secured in parallel with the other of the first and second frame members with the upper edge of each frame member disposed above the roller plane, the lower edge of each frame member disposed below the roller plane and the first end of each frame member laterally opposite the second end of the other frame member;
(b) a low-wall/low-wall configuration is one in which each of the first and second frame members is secured in parallel with the other of the first and second frame members with the upper edge of each frame member disposed below the roller plane, the lower edge of each frame member disposed above the roller plane and the first end of one frame member laterally opposite the second end of the other frame member; and
(c) a high-wall/low-wall configuration is one in which each of the first and second frame members is secured in parallel with the other of the first and second frame members, the upper edge of one frame member disposed below the roller plane, the upper edge of the other frame member disposed above the roller plane and the first end of each frame member laterally opposite the first end of the other frame member.

11. The framing kit of claim 10 further comprising at least one set of spur bracket-assembly components for facilitating the interconnection at a spur angle of the roller conveyor module with one of (i) a merging roller conveyor module from which material is received into the roller conveyor module and (ii) a diverting roller conveyor module to which material is transferred from the roller conveyor module, the bracket-assembly components including
(a) an elongated rail extending longitudinally along a rail axis and having first and second longitudinally opposed ends and a wall with an inside face and an outside face from which wall depends a set of roller-supporting tabs, each tab including a roller-mounting aperture therethrough and diverging outwardly from the outside face at a tab angle corresponding to the spur angle, the roller-mounting apertures of the roller-supporting tabs being spaced apart so as to define roller axes separated in accordance with a predetermined roller spacing, the elongated rail being adapted for fastening over at least a portion of the outer face of one of the first and second frame members included in the assembled roller conveyor module;
(b) a first, outside bracket having a base member and a first arm extending from the base member, the base member being adapted for fastening to the elongated rail such that, when the rail is attached to the frame member and the outside bracket is attached to the rail, the first arm extends along a first-arm axis defining, with the longitudinal axis of the frame member, an angle exterior to the first arm and the frame member greater than 90° and supplementary to the spur angle; and
(c) a second, inside bracket having a base member and second arm extending from the base member, the base member being adapted for fastening to the elongated rail such that, when the rail is attached to the frame member and the inside bracket is attached to the rail, the second arm extends along a second-arm axis defining, with the longitudinal axis of the frame member, an angle exterior to the second arm and the frame member less than 90° and corresponding to the spur angle.

12. The framing kit of claim 11 further including a bracket extender adapted for coupling with the outside bracket and having a set of roller-mounting apertures including a roller-mounting aperture corresponding to each roller mounting aperture included through a roller-supporting tab depending from the elongated rail, each roller-mounting aperture of the bracket extender being aligned with the counterpart of that roller-mounting aperture included through a roller-supporting tab for the mounting of a roller, each roller adapted for support by the elongated rail and the bracket extender having a roller length appropriate to the position of the tab by which that roller is to be supported, wherein, among the rollers adapted for support between the bracket extender and the elongated rail, the roller adapted for support by the tab closest to the outside bracket is the shortest and the roller adapted for support by the inside bracket is the longest and wherein each roller adapted for support between the bracket extender and the elongated rail, when so supported, is rotatable about a roller axis extending at an angle, with respect to the rail axis, corresponding to the spur angle.

13. The framing kit of claim 11 wherein, in at least a divert mode, the elongated rail is adapted for fastening to the outer face of one of the first and second frame members when that frame member is in a low-wall attitude such that the roller plane of the diverting roller conveyor module is no higher than the roller plane of the roller conveyor module to which the elongated rail is attached thereby presenting an obstruction to material flow from the latter roller conveyor module to the diverting roller conveyor.

14. A roller conveyor module framing kit adapted for incorporation in an assembled roller conveyor module including a roller support structure having first and second ends and left and right spaced apart arcuate frame members concentric about a center point and adapted for supporting a plurality of rollers between the left and right frame members for rotational motion about roller axes extending radially along a roller plane and converging toward the center point, the framing kit comprising:
an arcuate inner frame member including an arcuate wall with upper and lower edges, inner and outer faces and first and second arcuately opposed ends, the inner frame member having a first roller-mounting aperture set including roller mounting apertures arranged such that there exists a first arcuate roller-plane axis passing through each of the roller-mounting apertures in the first roller-mounting aperture set and such that the first roller-plane axis is closer to the lower edge than to the upper edge of the inner frame member; and
an arcuate outer frame member including an arcuate wall with upper and lower edges, inner and outer faces and first and second arcuately opposed ends, the outer frame member being defined by a larger radius of curvature than the inner frame member and having a second roller-mounting aperture set including roller mounting apertures arranged such that there exists a second arcuate roller-plane axis passing through each of the roller-mounting apertures in the second roller-mounting aperture set and such that the second roller-plane axis is closer to the lower edge than to the upper edge of the outer frame member;
wherein, when the inner and outer frame members are cooperatively assembled in a roller conveyor module, the first and second roller-plane axes correspond to the intersection of the roller plane and, respectively, the walls of the inner and outer frame members and wherein each of the inner and outer frame members includes a feature set that exhibits sufficient symmetry about at least one of (a) a first plane orthogonal to the roller plane axis of the frame member and (b) a second plane passing between the upper and lower edges of the frame member such that the inner and outer frame members are adapted for cooperative assembly in a roller conveyor module that is selectively configurable into at least one alternative configuration selected from among each of the following two configuration sets wherein each configuration is directionally defined as left-curving or right-curving with reference to an arbitrarily designated material flow direction and such that there exists lateral alignment among features in the feature set of the inner frame member with like features in the feature set of the outer frame member:
(a) a first configuration set wherein the inner and outer frame members are secured concentrically to one another with the first end of the inner frame member laterally opposite to the first end of the outer frame member, wherein the first configuration set comprises:
(i) an inner high-wall/outer high-wall, left-curving configuration in which the upper edge of each frame member is disposed above the roller plane, the lower edge of each frame member is disposed below the roller plane and the first ends of the inner and outer frame members correspond to the first end of the roller support structure;
(ii) an inner low-wall/outer low-wall, left-curving configuration in which the lower edge of each frame member is disposed above the roller plane, the upper edge of each frame member is disposed below the roller plane and the first ends of the inner and outer frame members correspond to the second end of the roller support structure;
(iii) an inner high-wall/outer high-wall, right-curving configuration in which the upper edge of each frame member is disposed above the roller plane, the lower edge of each frame member is disposed below the roller plane and the first ends of the inner and outer frame members correspond to the second end of the roller support structure; and
(iv) an inner low-wall/outer low-wall, right-curving configuration in which the lower edge of each frame member is disposed above the roller plane, the upper edge of each frame member is disposed below the roller plane and the first ends of the inner and outer frame members correspond to the first end of the roller support structure; and
(b) a second configuration set wherein the inner and outer frame members are secured concentrically to one another with the first end of the inner frame member laterally opposite to the second end of the outer frame member, wherein the second configuration set comprises:
(i) an inner high-wall/outer low-wall, left-curving configuration in which the upper edge of the inner frame member is disposed above the roller plane, the lower edge of outer frame member is disposed above the roller plane and the first end of the inner frame member and the second end of the outer frame member correspond to the first end of the roller support structure;
(ii) an inner low-wall/outer high-wall, left-curving configuration in which the lower edge of the inner frame member is disposed above the roller plane, the upper edge of outer frame member is disposed above the roller plane and the first end of the inner frame member and the second end of the outer frame member correspond to the second end of the roller support structure;
(iii) an inner high-wall/outer low-wall, right-curving configuration in which the upper edge of the inner frame member is disposed above the roller plane, the lower edge of outer frame member is disposed above the roller plane and the first end of the outer frame member and the second end of the inner frame member correspond to the first end of the roller support structure; and
(iv) an inner low-wall/outer high-wall, right-curving configuration in which the lower edge of the inner frame member is disposed above the roller plane, the upper edge of outer frame member is disposed above the roller plane and the first end of the inner frame member and the second end of the outer frame member correspond to the first end of the roller support structure.

15. The framing kit of claim 14 wherein the feature set of each of the inner and outer frame members comprises at least one of
(i) fastener apertures;
(ii) apertures for the receipt of optical barrier apparatus;
(iii) apertures for facilitating the passage of electromagnetic energy emitted from an emitter for detection by a receiver of cooperating optical barrier apparatus;
(iv) the cross sectional geometry of the frame member; and
(v) the roller-mounting apertures.
